(19) United States
(12) Patent Application Publication
(10) Pub. No.: US 2014/0007158 A1
(43) Pub. Date: Jan. 2, 2014

(54) EMERGENCY ALERT SYSTEM (EAS) ALERT GENERATION

(71) Applicant: Amol Bhagwat, Louisville, CO (US)

(72) Inventor: Amol Bhagwat, Louisville, CO (US)

(73) Assignee: CABLE TELEVISION LABORATORIES, INC., Louisville, CO (US)

(21) Appl. No.: 13/537,265

(22) Filed: Jun. 29, 2012

(51) Int. Cl. H04N 21/236

(52) U.S. Cl. 725/33

(57) ABSTRACT

Providing emergency alert system (EAS) alerts to IP-based devices inside and outside a home is contemplated. The EAS alerts may be provided through television signals for output on one or more televisions and simultaneously to Internet-Protocol (IP)-based devices such as tablets, game consoles, cellular phones, mobile computer, IP-STBs, televisions with IP connectivity or non-television dependent devices.

### TECHNICAL FIELD

The present invention relates to providing emergency alert system (EAS) alerts, such as but not necessarily limited to providing EAS alerts to television and non-television or Internet Protocol (IP) types of devices.

### BACKGROUND

Society of Cable Telecommunications Engineers specification, entitled Emergency Alert Signaling for the Home Network (ANSI/SCTE 162 2009 (J-STD-070-2010 A Joint Standard Developed by SCTE and CEA) Emergency Alert Signaling for the Home Network), the disclosure of which is hereby incorporated by reference in its entirety, standardizes metadata elements describing emergency alert events to devices in a home network, for applications involving the delivery of Commercial Video Services into the home network. Commercial Video Services are sources of audio/video content provided as live or on-demand streams from a particular service provider. Other standards define emergency alert signaling for digital cable receiving devices (ANSI J-STD-042-A, Emergency Alert Messaging for Cable, November 2007, also known as SCTE 18 2007, the disclosure of which is hereby incorporated by reference in its entirety) and for IPTV terminal devices (ATIS-0800012 IPTV Emergency Alert System Metadata Specification, June, 2008, Alliance for Telecommunications Industry Solutions, the disclosure of which is hereby incorporated by reference in its entirety).

Receiving devices in the home with access to Commercial Video Services may wish to place such content on a home network. SCTE 162 defines a metadata format usable by these receiving devices to notify client devices in the home network of emergency alert information including text, audio, and specific details about the alert (such as originator and event code, severity, etc.). Some types of alerts are urgent enough that they trigger client devices to immediately switch to another channel offered by that service provider which is a source of live audio/video describing details of the alert (the “Details Channel”). The metadata format described in SCTE 162 provides a pointer to the Details Channel for such cases. When outputting live programming on a channel defined in the schema as an “Exception Channel,” client devices remain tuned to that channel to receive details of the alert.

SCTE 162 does not specify required receiver behavior. The purpose of SCTE 162 is to standardize the delivery format and syntax and semantics of the emergency alert metadata, which is specified in the form of an XML Schema and associated element definitions. SCTE 162 also does not describe transport protocols and methods for the delivery of the emergency alert metadata in the home network. Accordingly, the present invention perceives a need to address the delivery of such emergency alert metadata and other EAS related data in the home network.

### BRIEF DESCRIPTION OF THE DRAWINGS

FIG. 1 illustrates a system for providing an emergency alert system (EAS) alerts as contemplated by one non-limiting aspect of the present invention.

FIG. 2 illustrates a message flow diagram associated with a method for providing EAS alerts as contemplated by one non-limiting aspect of the present invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

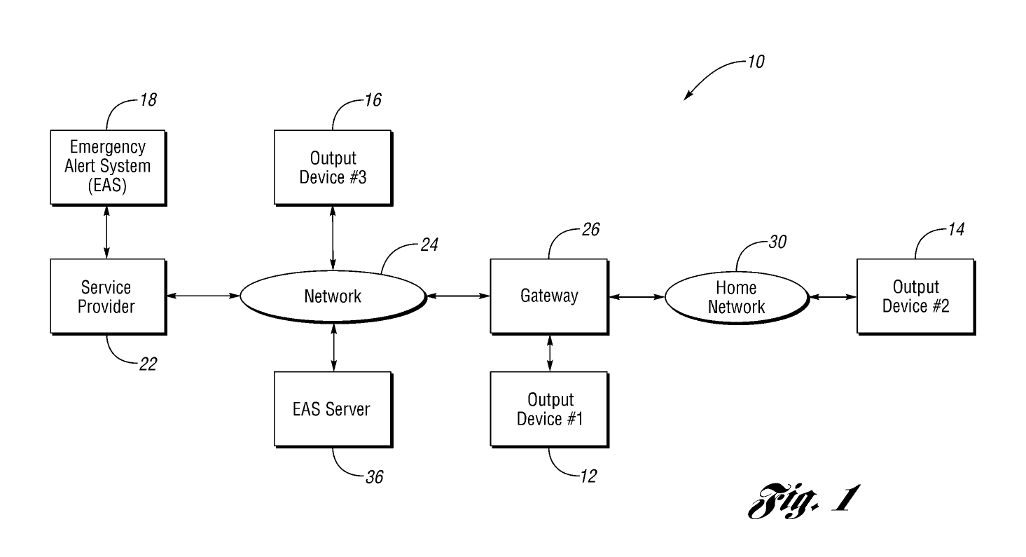

FIG. 1 illustrates a system 10 for providing an emergency alert system (EAS) alerts as contemplated by one non-limiting aspect of the present invention. The system 10 may be configured to facilitate generation of an EAS alert or other suitable warning at one or more output devices 12, 14, 16. The system 10 is described with respect to facilitating generation of the EAS alert in response to EAS source messages issued from an EAS 18, which for example may be a governmental emergency entity (e.g. national weather service, city-municipal corporations, police, fire, military, etc.) or other entity desiring communication of EAS alerts or other types of messages to certain output devices 12, 14, 16. The system 10 is predominately described with respect to the EAS source message being carried over a hybrid-fiber coax (HFC) system associated with a cable television infrastructure in accordance with SCTE 162. The present invention, however, is not necessary so limited and fully contemplates the EAS alerts being delivered according to any suitable protocol or standard, across any cable or non-cable network 20 (e.g., a cellular network, optical network, satellite network, Wi-Fi network, telephone network, etc.), and to any number of output devices.

The system 10 may include a service provider (SP) 22 configured to provide services for one or more subscribers. The services may include those associated with a cable television service provider, a satellite television service provider, an Internet service provider (ISP), a high speed data (HSD) service provider, a multiple system operator (MSO), a cellular phone service provider, a wireless or Wi-Fi service provider, a voice over Internet protocol (VoIP) service provider, or other type of service provider tasked with providing services to output devices. The service provider 22 may be configured to facilitate services with signaling carried over a wireline and/or wireless network 24. The output devices 12, 14, 16 may correspond with any devices sufficient to access the desired services, including but not limited to a computer, phone, personal digital assistant (PDA), media terminal adaptor (MTA), tablet, television, digital video recorder (DVR), etc. One or more gateways 26 may be included to facilitate interfacing signaling between the service provider 22 and the output devices 12, 14. The gateway 26 may be a cable modem (CM), router, settop box (STB), network address translator (NAT) or other device having capabilities sufficient to interface signaling, including those sufficient to interface or descramble proprietary signaling associated with the service provider 22.

The present invention contemplates the service provider 22 being required or otherwise tasked with delivering EAS alerts to the output devices 12, 14, 16. The system 10 is predominately described with respect to the service provider 22 leveraging off of known geographical locations of their service network and subscribers to facilitate delivery of EAS alerts depending on a geographical area subjected to the EAS alert. While a single network 24 is shown, it is contemplated that the illustrated network 24 may be segmented into a plurality of and/or private networks having cable modem termination stations (CMTSs), headend units, switches or other types of hardware to support signaling at different locations such that the known geographical areas may be determined with geographical specificity equivalent to the known locations of the hardware components supporting signaling. The service provider 22 may be configured to determine the geographical area subjected to a computer EAS alert according to geographical characteristics or other parameters included within a corresponding EAS source message. The geographical information included in the EAS source message may be the extent of the geographical or recipient identifying information such that the service provider 22 is required to assess the output devices 12, 14, 16 requiring the corresponding EAS alert.

The service provider 22 may be configured to cross-reference one or more geographical characteristics specified in the EAS source message with known geographical locations of the output devices 12, 14, 16 in order to identify those in need of the EAS alert. This may include identifying the output devices 12, 14, 16 specifically, e.g., according to an IP address, a MAC address etc., or the associated subscribers, either individually or geographically, e.g. a ZIP code, street address, etc. Location information sufficient for identifying the area subjected to EAS alert may also be determined by cross-referencing known location information associated with a serial number, MAC address or IP addresses of the gateway 26 or other interface identified within signaling from output devices. FIG. 1 illustrates an exemplary configuration where a first and a second one of the output devices 12, 14 are connected through a gateway 26 and a third one of output devices 16 is connected directly to the network 24. This scenario may occur, for example, in the event the gateway 26 is a cable modem or STB configured to facilitate descrambling proprietary signaling of the service provider, such as to facilitate delivery of services over a home network 30, and the third device 16 is connected to the Internet either directly or through another gateway, such as at a Wi-Fi or wireless hotspot location associated with a different service provider or at another location associated with the same service provider 22.

The present invention presumes each of the first, second and third output devices 12, 14, 16 are associated with one or more subscribers within the EAS alert domain of the service provider 22 such that the service provider 22 is required to provide them relevant EAS alerts. The third device 16, for example, may be accessing services of the service provider while outside of their “home” location, such as through a web portal or other interface that mimics the service typically available to them at the “home” location. Accordingly, the present invention contemplates the service provider 22 being configured to facilitate individually addressing signaling to each of output devices 12, 14, 16 sufficient to facilitate generating the corresponding EAS alert, optionally regardless of a current position of the output device 12, 14, 16. The present invention also fully contemplates one or more of the output devices 12, 14, 16 being associated with non-subscribers or others beyond the EAS alert requirements of the service provider 22, such as but not necessary limited to output devices 12, 14, 16 that have temporarily been granted access to the service provider services, e.g., temporary access to the home network associated with signaling of the service provider 22. The service provider 22 may be configured to facilitate delivery of relevant EAS alerts to these types of visiting output devices, including relying on addressing or other information associated with the gateway 26 or other connection point through which they are receiving services.

The present invention contemplates facilitating EAS alerts to subscriber devices 12, 14, 16 when the subscriber devices 12, 14, 16 are at known or unknown locations and to facilitate EAS alerts with visiting devices 12, 14, 16 which otherwise would not be within the EAS alert responsibilities of the service provider 22, e.g., visiting devices 12, 14, 16 that have temporarily registered to receive services. The output devices 12, 14, 16 requiring EAS alerts may be limited to those currently at location within the geographical area subjected to the EAS alert and/or more broadly to a device outside the affected area if the subscriber of that devices 12, 14, 16 is typically located in an area subjected to the EAS alert. This may include notifying subscribers of EAS alerts occurring at the primary location while the subscribers actually traveling to another location, e.g., to notify a subscriber of a problem at their home while they are at a location away from their home. The present invention contemplates at least facilitating transmission of EAS alerts where the gateway 26 may be configured to communicate the EAS alert to each of its connected devices 12, 14 (i.e., a one-to-many distribution of EAS alerts, which may optionally occur without the service provider 22 being aware of the devices 12, 14 connected to the gateway 26, and/or through direct signaling with the output devices 12, 14 using known addressing (i.e., a one-to-one distribution of EAS alerts), which may require the service provider 22 to be aware of the devices 12, 14.

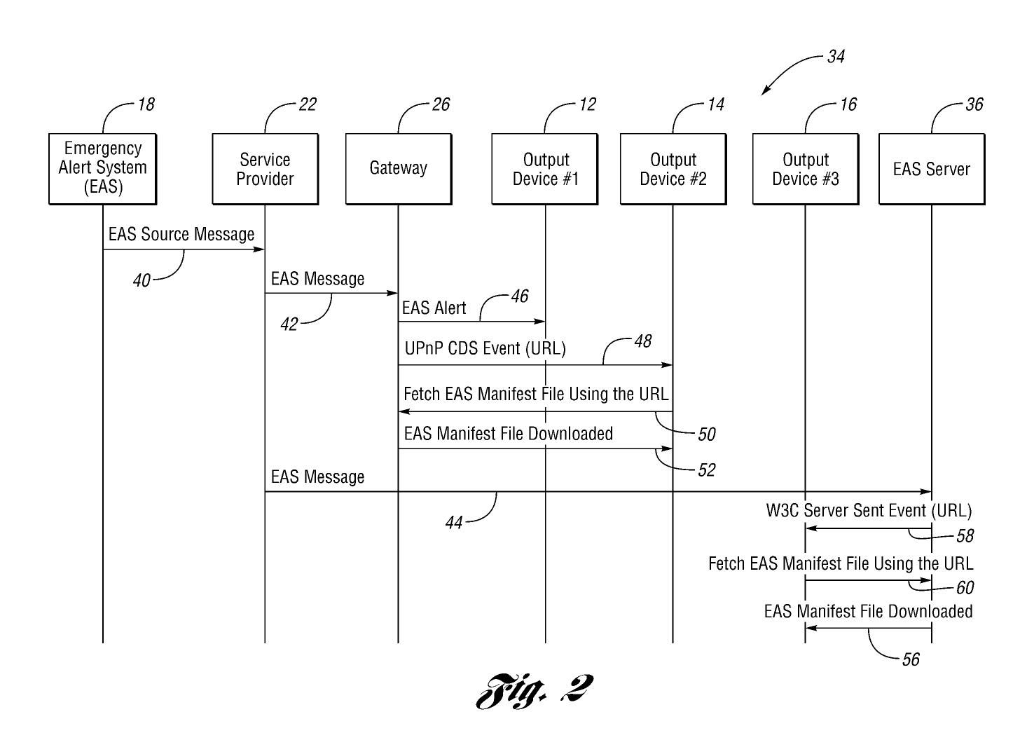

FIG. 2 illustrates a message flow diagram 34 associated with a method for providing EAS alerts as contemplated by one non-limiting aspect of the present invention. The method may be associated with a non-transitory computer-readable medium of the service provider 22, gateway 26 or other one of the components shown in FIG. 1 having computer-readable code embodied therein for controlling an associated computing device to facilitate an EAS alert. The computer-readable medium may include instructions sufficient for executing operations contemplated by the present invention, either individually or in cooperation with commands and instructions issued to other devices associated with the system 10. The method may be beneficial in facilitating EAS alerts to devices 12, 14, 16 according to their specific protocol requirements and/or generically to devices 12, 14, 16 having capabilities to facilitate Internet protocol (IP). The EAS alerts may be executed according to instructions or data downloaded in a file from a web server or an EAS server 36 (see FIG. 1). The ability to generate generic or IP-based EAS alerts may be beneficial in allowing the system to leverage off of known or existing EAS infrastructures (e.g., SCTE 162) to facilitate generating EAS alerts to devices which may not be compliant with the known or existing EAS infrastructures.

The process contemplated to facilitate providing the EAS alerts may be instigated with an EAS source message 40 communicated from the EAS 18 to the service provider 22. The EAS source message 40 may include information regarding a nature of the EAS alert, including information regarding the type, format, urgency, content and geographical area(s) of to the EAS alert. The service provider 22 may be configured to generate EAS messages 42, 44 according to the information included within the EAS source message 40. The EAS messages 42, 44 may be used to facilitate appraising the gateway 26, EAS server 36 or output devices 12, 14, 16 of the EAS alert to be generated. The EAS messages 42, 44 may prompt or command the gateway 26 or EAS server 36 to generate an EAS manifest file for subsequent download by one or more of the output devices 12, 14, 16. The downloadable files may be formatted to prompt output of the EAS alert according to the operation parameters of the output devices 12, 14, 16.

FIG. 2 illustrates a scenario where the service provider 22 generates first and second EAS messages 42, 44 respectively for the gateway 26 and the EAS server 36. The first and second message 42, 44 may be copies of the same message or uniquely formatted according to the requirements of the gateway 26 and EAS server 36. The second EAS message 44 may be transmitted to the EAS server 36 over the Internet or through another suitable network. In the event the gateway 26 is a STB or other device connected to a private network or service specific network 24 of the service provider 22, e.g., its television signaling network, the EAS message 42 may be transmitted to the gateway 26 within normal television signaling. The gateway 26 may be configured to process the EAS message 42 to facilitate output of the EAS alert with the connected output devices 12, 14. The communication of the EAS alert to the output devices 12, 14, for example with respect to the first gateway 26, may include communicating over a High-Definition Multimedia Interface (HDMI) cable to a television (device 12) and over a wireless home network to a computer (device 14).

The gateway 26 may be configured to output an EAS alert 46 within television signals carried though the HDMI cable to be descrambled for output with the television 12. The television 12 may automatically output the EAS alert when embedded in the television signaling, i.e., as if it was part of the television signals being descrambled for viewing. The EAS message 42 may prompt the gateway 26 to transmit a universal resource locator (URL) 48 or other type of location pointer to the second output device 14 or any additional device connected to the gateway 26, such as over a wireless connection of the home network 30. This may include transmitting the URL 18 to any device 14 which is not being actively descrambling television signals for output, i.e., a device 14 that is not outputting television signals having the EAS alert 46 embedded therein. The corresponding gateway 26 may be unable to force output of an EAS alert at the second output device 14 by embedding EAS alert signals within television signals. The URL 48 may be communicated as a UPnP Content Directory Service (CDS) content item, as a server sent event or other suitable operation, such as described in UPnP Version 1.0, the disclosure of which is hereby incorporated by reference in its entirety.

The URL 48 may be used to command the second device 14 to download 50 an EAS manifest file from the gateway. The EAS manifest file 52 may be included within the EAS message 42 and/or generated by the gateway 26 in response to information included therein. The EAS manifest 52 may be formatted to facilitate IP-based communication such that it can be communicated over the home network 30 to any IP-enabled device 14. This may include the EAS manifest file 52 being formatted as an xml schema having instructions sufficient to facilitate output of the EAS alert according to the operating requirements of the second output device 14. The EAS manifest file 52 may correspond with the metadata format defined in SCTE 162, which may be usable by the receiving device 14 to notify connected client devices in the home network 30 of emergency alert information including text, audio, and specific details about the alert (such as originator and event code, severity, etc.). The EAS manifest 52 may be urgent enough that they trigger client devices 14 to immediately switch to another channel offered by that service provider 22 which is a source of live audio/video describing details of the alert (the “Details Channel”). The metadata format described in SCTE 162 provides a pointer to the Details Channel for such cases, e.g., commanding the second output device 14 to output the desired EAS alert by tuning to a certain channel and/or to download information from a website or a service otherwise associated with the SCTE 162 pointer.

The service provider 22 may be configured to generate the EAS message 42 to include the EAS manifest file 52 with instructions sufficient to facilitate commanding various types of devices 12, 14 to communicate the desired EAS alert. The EAS manifest file 52 downloaded from the gateway 26 by the second device 14, therefore, may include a number of different instructions set and/or configurations for the EAS alert. The second output device 14 may process a suitable portion of the downloaded EAS manifest file 52 in order to generate the desired EAS alert. The EAS manifest file 52 may include an emergency alert video message to be played by the second output device when generating the EAS alert. The EAS manifest file 52 may include instructions sufficient for commanding the second output device 14 to perform a corresponding forced tune alert. The EAS manifest file 52 may include an emergency alert audio message to be played by the second output device 14 when generating the EAS alert. The EAS manifest file 52 may include instructions sufficient for commanding the second output device 14 to perform a corresponding audio alert. The EAS manifest file 52 may include a text message to be played by the second output device 14 when generating the EAS alert. The EAS manifest file 52 may include instructions sufficient for commanding the second output device 14 to perform a corresponding text alert.

The process of facilitating an EAS alert at the third output device 16 may be similar in that the EAS message 44 provides a second EAS manifest file 52 to the EAS server 36 for storage and download using a second URL 58 transmitted to the third output device 16 to prompt 60 a download. The service provider 22 may be configured to determine a location of the third device 16 from an address being used by it to facilitate communications such that the service provider 22 may facilitate output of EAS alerts at the third device 16 that are specific its current location. This may be particularly beneficial in allowing the service provider 22 to facilitate EAS alerts for subscribers accessing services of the service provider 22 through a web portal or other non-traditional interface. The service provider 22 may also be configured to provide the third device 16 with EAS alerts that are not specific to their current location, such as to provide EAS alerts relevant to the associated subscribers home location. This may be beneficial in apprising the subscriber of alert while traveling to another location not necessarily subjected to the EAS alert, e.g. to warn the subscriber of a storm at their home location while actually being located in an area beyond the reach of the storm.

As supported above, one non-limiting aspect of the present invention contemplates providing text, audio and video Emergency Alert (EA) Messages to IP devices. The present invention may be used by a video service provider when delivering live premium content services to IP devices to meet EAS regulatory obligation. A service provider, for example, may create an EA manifest file that contains the following information, depending on the type of the EA message: a URL to the emergency alert video message, if the EA message is a forced tune alert; a URL to the emergency alert audio message, if the EA message is audio+text alert; and a URL to the emergency alert text message or actual contents of the text message, if the EA message is text only or audio+text alert. The URL may be a pointer separate from a pointer included in an EAS manifest file or otherwise used to download the actual EAS alert. The format of EAS manifest file can be proprietary to a service provider or XML format specified in CEA 2035/SCTE 162 can be used.

The service provider may make the EAS manifest file available at a specific URL for certain period of time and/or multiple EAS manifest files may be constructed and pointed to with different URLs. Contents of EAS manifest file may be updated every time a new EA message is received by the service provider from National Weather Service other sources or other EASs. For regional EA messages, a service provider will have region specific URLs. In case of a DLNA device connected to the home network, a service provider may populate the EA manifest file URL in a well-known CDS content item. A CDS event is generated when there is an update to the EA manifest file. This triggers the DLNA client device to fetch the EA manifest file. In case of a generic IP client receiving live services, the EA manifest file URL may be provided to an IP client during initial set up through an MSO application on the IP client. This could be could be a native application on the IP client or a RUI application. An event (e.g. Server Sent Events) is sent to this application from a service provider server when there is an update to the EA manifest file. This triggers the IP client device to fetch the EA manifest file. After the client receives the manifest file, depending on the contents of the EA manifest file, it may access appropriate URLs and displays EA message appropriately.

When MVPD live content services are extended to IP devices within home, emergency alert messages may be delivered to those IP devices in accordance with the present invention. The present invention may be able to facilitate EAS alert by leveraging capabilities to provide alerts to STB devices to other devices connected to cable operator's HFC network. The present invention can be used when MVPD services are offered to in-home IP devices either using a STB device in the home or directly from the cloud. Because the invention can utilize a DLNA/UPnP CDS content item to populate URL of the EA manifest file, the solution enables serving the EA manifest file from the cloud when the IP client is outside the home and serving it from the in-home STB/gateway when the IP-client is within home behind the STB/gateway. This may be useful from scalability point of view. The present invention may be used to enable MVPDs to meet their regulatory obligation of providing emergency alert messages when offering live content services to IP devices. The present invention may be used for offering emergency alert messages to any generic IP-based device as well as for DLNA device.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A system for providing emergency alerts comprising:
a service provider configured to transmit television signals, the service provider being configured to transmit a first emergency alert system (EAS) message with the television signals, the service provider being configured to generate the first EAS message in response to receipt of an EAS source message from an emergency entity; and
a gateway configured to process the television signals for output by a television, the gateway being configured to embed the EAS alert within the television signals output to the television according to information included within the first EAS message, wherein the gateway is further configured to transmit a first URL to a first device, the first URL pointing to a first EAS manifest stored at the gateway, the first device using the first URL to download the first EAS manifest from the gateway for use in generating the EAS alert.

2. The system of claim 1 wherein the service provider is configured to transmit a second EAS message to a web server configured to store files for download over the Internet, the second EAS message identifying a second device outside of a geographical area specified in the first EAS message that is intended to receive the EAS alert, the web server transmitting a second URL to the second device identified in the second EAS message, the second URL pointing to a second EAS manifest file stored at the web server, the second device using the second URL to download the second EAS manifest file for use in generating the EAS alert.

3. The system of claim 1 wherein the first device is unable to generate the EAS alert from the first EAS message, the first device relying on metadata include within the first EAS manifest to generate the EAS alert, the first EAS manifest file including an emergency alert video message to be played by the first device when generating the EAS alert, the first EAS manifest file instructing the first device to perform a forced tune alert, the force tune alert resulting in the first device playing the emergency alert video message.

4. The system of claim 1 wherein the first device is unable to generate the EAS alert from the first EAS message, the first device relying on metadata include within the first EAS manifest to generate the EAS alert, the first EAS manifest file including an emergency alert audio message to be played by the first device when generating the EAS alert, the first EAS manifest file instructing the first device to perform an audio alert, the audio alert resulting in the first device playing the emergency alert audio message.

5. The system of claim 1 wherein the first device is unable to generate the EAS alert from the first EAS message, the first device relying on metadata include within the first EAS manifest to generate the EAS alert, the first EAS manifest file including a text message to be played by the first device when generating the EAS alert, the first EAS manifest file instructing the first device to perform a text alert, the text alert resulting in the first device displaying the text message.

6. The system of claim 1 wherein the gateway is configured to transmit the first URL to an Internet protocol (IP) address of the first device.

7. The system of claim 1 wherein the gateway is configured to transmit the first URL to the first device as part of a UPnP Content Directory Service (CDS) event.

8. The system of claim 1 wherein the gateway is configured to transmit the first URL to the first device as part of a server sent event.

9. The system of claim 1 wherein the gateway transmits the first URL to the first device over a home network associated with the gateway, the gateway being configured to process all Internet Protocol IP signaling between the home network and the Internet.

10. The system of claim 9 wherein the gateway selects the first device from a plurality of registered devices, the registered devices having previously completed a registration process with the gateway to access the Internet through the home network, wherein the gateway is associated with a settop box (STB), the STB processing the television signals for output to the television.

11. The system of claim 1 wherein the gateway is configured to generate the first EAS manifest file according to information included with the first EAS message, the service provider transmitting the first EAS manifest to a plurality of additional gateways located in a geographical area subjected to the EAS alert, the plurality of additional gateways being associated with subscribers of the service provider, the plurality of additional gateways being configured to process the television signals for output to associated televisions, including embedding the EAS alert within the television signals output to the associated televisions according to information included within the first EAS message

12. The system of claim 11 wherein the first EAS manifest file is in the form of an xml schema defined according to Society of Cable Telecommunications Engineers (SCTE) 162.

13. A non-transitory computer-readable medium having computer-readable code embodied therein for controlling a gateway to facilitate an emergency alert system (EAS) alert, the computer-readable medium comprising instructions sufficient for:
receiving an EAS message used to define the EAS alert;
embedding the EAS alert within television signals output to a television connected via a wired connection to the gateway;
generating an EAS manifest file having instructions sufficient to facilitate output of the EAS alert with a local device connected via a wireless connection to the gateway; and
transmitting a universal resource locator (URL) to the local device, the URL pointing to a storage location on the gateway from which the local device downloads the EAS manifest file in order to output the EAS alert.

14. The computer-readable medium of claim 13 further comprising instructions sufficient for transmitting the EAS alert to the television through a High-Definition Multimedia Interface (HDMI) and the URL to the local device through a wireless network interface.

15. The computer-readable medium of claim 13 further comprising instructions sufficient for addressing the URL to an Internet Protocol (IP) address of the local device determined as part of a network registration process used to grant the local device access to a wireless home network associated with the gateway.

16. The computer-readable medium of claim 13 further comprising instructions sufficient for:
notifying a remote device of the EAS alert using transmission of a notification message carried over the Internet, the remote device being connected to the Internet at a location remote from a wireless home network supported by the gateway, the local device being wirelessly connected to the wireless home network and required to communicate through the gateway in order to connect to the Internet; and
determining the remote device based on an association with a subscriber responsible for the gateway where the subscriber requests providing the EAS alert to non-local devices accessing the internet while connected outside of the home network.

17. A method for providing an emergency alert system (EAS) alert comprising:
receiving an EAS source message from an emergency entity, the EAS source message identifying the EAS alert;
identifying a plurality of devices through which the EAS alert is to be output;
identifying at least a first device and a second device of the plurality of the devices to be associated with a first gateway, the first gateway being configured to process television signals for output by the first device and to provide Internet access to the second device;
identifying at least a third device of the plurality of devices to be connected to the Internet through a second gateway;
transmitting a first EAS message to the first gateway, the first EAS message being sufficient to facilitate:
i) instructing the first gateway to embed the EAS alert within the television signals;
ii) storing a first EAS manifest file at the gateway, the first EAS manifest file having instructions operable with the second device to facilitate output of the EAS alert;
iii) instructing the gateway to transmit a first locator pointing to the first EAS manifest file stored at the first gateway to the second device, the first locator instructing the second device to download the first EAS manifest file to facilitate output of the EAS alert;
transmitting a second EAS message to a web server, the second EAS message being sufficient to facilitate:
i) storing a second EAS manifest file at the web server, the second EAS manifest file having instructions operable with the third device to facilitate output of the EAS alert
ii) instructing the web server to transmit a second locator pointing to the second EAS manifest file stored at the web server to the third device, the second EAS manifest instructing the third device to download the second EAS manifest file to facilitate output of the EAS alert.

18. The method of claim 17 further comprising the first EAS manifest being sufficient to facilitate instructing the first gateway to transmit the EAS alert to the first device through a High-Definition Multimedia Interface (HDMI) and to transmit the first locator to the second device through a home network interface.

19. The method of claim 18 further comprising the first EAS message being sufficient to facilitate instructing the first gateway to transmit the first EAS manifest to any IP device connected through the home network interface, wherein at least one of the IP devices was not identified as one of the plurality of devices, wherein the first gateway is configured to process the television signals for output using non-IP-based signaling and to provide the Internet access to the second device using IP-based signaling.

20. The method of claim 17 further comprising identifying the plurality of devices through which the EAS alert is to be output, including the first, second and third devices, as a function of a geographical area noted within the EAS source message, the identified devices being those associated with a subscriber having a home location within the geographical area, wherein a location of the first gateway is within the geographical area and a location of the second gateway is outside of the geographical area.
